(19) United States
(12) Patent Application Publication
(10) Pub. No.: US 2016/0046533 A1
(43) Pub. Date: Feb. 18, 2016

(54) PROCESS FOR THE PRODUCTION OF AMMONIUM/POTASSIUM POLYPHOSPHATE COMPOUNDS FROM POTASSIUM CHLORIDE AND PHOSPHORIC ACID FEEDSTOCKS

(71) Applicant: K-TECHNOLOGIES, INC., Lakeland, FL (US)

(72) Inventors: William W. BERRY, Lakeland, FL (US); Thomas E. BAROODY, Lakeland, FL (US)

(21) Appl. No.: 14/775,466

(22) PCT Filed: Mar. 14, 2014
(86) PCT No.: PCT/US14/27740

§ 371 Date: Sep. 11, 2015

Related U.S. Application Data
(60) Provisional application No. 61/799,867, filed on Mar. 15, 2013.

(51) Int. Cl. C05B 7/00; C05D 3/00; C05C 3/00; C05B 17/00; C05G 3/00

(52) U.S. Cl. CPC C05B 7/00; C05B 17/00; C05G 3/0064; C05C 3/00; C05D 3/00

(57) ABSTRACT

The present invention relates to a continuous ion exchange methodology for production of ammonium-potassium polyphosphate solutions using agricultural grade phosphoric acid, anhydrous ammonia, and agricultural grade potassium chloride (ag potash) as primary feedstocks. The method is particularly applicable to the production of these low salt index, specialty liquid fertilizer solutions and allows for the use of less expensive ag-potash and impure phosphoric acid as the potassium and phosphate sources in order to produce the ammonium-potassium polyphosphate compounds, which are chloride free as a result of the ion ex-change process.

### RELATED APPLICATIONS

This application is a Patent Convention Treaty (PCT) International Application which claims benefit of priority to U.S. Provisional Patent Application Ser. No. (USSN) 61/799,867, filed Mar. 15, 2013, which is expressly incorporated by reference herein in its entirety for all purposes.

### TECHNICAL FIELD

This invention generally relates to fertilizer products and production processes for making liquid fertilizer products. In alternative embodiments, the invention provides continuous ion exchange methodologies for production of ammonium-potassium polyphosphate solutions using agricultural-grade phosphoric acid, anhydrous ammonia, and agricultural-grade potassium chloride (ag potash) as primary feedstocks. In alternative embodiments, the methods are particularly applicable to the production of low salt index, specialty liquid fertilizer solutions, and allows for the use of less expensive ag-potash and impure phosphoric acid as the potassium and phosphate sources in order to produce the ammonium/potassium polyphosphate compounds, which are chloride free as a result of the ion exchange process.

### BACKGROUND

Specialty liquid fertilizers have experienced significant growth over the past several decades and offer a number of agronomic and economic advantages over the more traditional solid fertilizer products. More direct application; the ability to combine other agricultural chemicals into the fertilizer mix; and minimized run-off or overuse are just several of these attributes.

In addition, there are a number of crops wherein the use of chloride-containing fertilizers, e.g. potassium chloride, are undesirable so in many cases a much more expensive potassium source is required, or alternatively, the lower cost chloride-containing potassium is used even though a low-chloride material would be more desirable. To this end, a more economic source of low-chloride liquid fertilizers would be desirable.

In many instances, the specialty liquid fertilizers are produced using technical-grade products, such as phosphoric acid and potassium hydroxide. This results in a low-chloride, high quality fertilizer solution, but at a significant cost premium when compared to products made with the higher volume commodity raw materials such as ag-grade phosphoric acid and potash. Thus, there is a distinct niche for a more economic liquid fertilizer material that can offer the benefits of the higher valued specialties, but at somewhat of a lower cost.

### SUMMARY

In alternative embodiments, the invention provides processes for the production of NPK-polyphosphate materials using agricultural-grade phosphoric acid and potash in a continuous ion exchange resin.

The continuous ion exchange resin can be a weak cationic material, or a strong cationic material. In alternative embodiments, the continuous ion exchange resin comprises a weak cationic material, and optionally the weak cationic material comprises: a weak acid resin; a weak acid, macroporous cation exchange resin; a DOWEX MWC-1™ (Dow Chemical Co., Midland, Mich.); a PUROLITE C-104+™ (Purolite, Bala Cynwyd, Pa.); or, an equivalent type of resin. In alternative embodiments, the continuous ion exchange resin comprises: a strong cationic material; a strong cationic exchange resin; a DOW 650C™ (Dow Chemical Co., Midland, Mich.); a PUROLITE SST 60™ (Purolite, Bala Cynwyd, Pa.); a LANXESS 1368/320™ (Lanxess AG, Cologne, Germany); or, an equivalent type of resin

In alternative embodiments, processes of the invention comprise an initial treatment of the phosphoric acid with ammonia to produce an ammonium polyphosphate solution. In alternative embodiments, the ammonium polyphosphate solution is then contacted in a continuous ion exchange system with an organic ion exchange resin that has been put into a potassium (K+) form to produce an ammonium/potassium polyphosphate steam that contains substantially no chloride values.

In alternative embodiments, after the ion exchange resin is loaded with ammonium it is contacted with a stream of potassium chloride solution to remove the ammonium ions from the resin as an ammonium chloride stream, and then the ammonium ions are replaced with potassium ions for subsequent reuse of the resin in the regeneration stage.

In alternative embodiments, where the amount of ammonium polyphosphate solution is such that a slight deficiency of ammonium ions are present for a full exchange with the production of a resulting polyphosphate solution that is substantially potassium polyphosphate.

In alternative embodiments, the ammonium chloride solution is evaporated and dried to produce a crystallized ammonium chloride product. In alternative embodiments, the ammonium chloride solution is reacted with a mixture of slaked lime to produce a calcium chloride co-product with subsequent recovery of the ammonium hydroxide.

In alternative embodiments, the ammonium polyphosphate solution is contacted in a continuous ion exchange system comprising an organic ion exchange resin that has been put into a potassium (K+) form to produce an ammonium/potassium polyphosphate steam that comprises substantially no chloride values, at a temperature ranging from between about 60° F. to about 160° F., or between about 110° F. to about 130° F., and at a sufficient pressure to overcome the pressure drop associated with the resin beds.

In alternative embodiments, the ion exchange resin, after loading with ammonium, is contacted with a stream of potassium chloride solution to remove the ammonium ions from the resin as an ammonium chloride stream, and optionally the ammonium ions are replaced with potassium ions for subsequent reuse of the resin in the regeneration stage; optionally at a temperature ranging from between about 60° F. to about 160° F., or between about 110° F. to about 130° F., and at a pressure sufficient to overcome the pressure drop associated with the resin beds.

The invention provides processes for the production of NPK-polyphosphate materials, or a liquid fertilizer solution that is substantially chloride-free, comprising:

(a) an initial treatment of a phosphoric acid with an ammonia to produce an ammonium polyphosphate solution, wherein optionally the phosphoric acid is agricultural grade;

(b) reaction of the ammonium polyphosphate solution to produce a potassium polyphosphate comprising the step:

R—K++NH₄-poly phosphate R—NH₄++K-poly phosphate

where R is the IX resin phase,

wherein the potassium polyphosphate solution comprises an ammonium/potassium solution or a full potassium polyphosphate solution, and the resin is now in the ammonium phase,

and optionally the solution is further evaporated; and

(c) the resin, now in the ammonium phase, is regenerated to convert it back to the potassium state by a process comprising initially contacting the resin with a small amount of water to wash the resin and remove any entrained phosphate solution, and then the resin is contacted with a solution of potassium chloride (potash) prepared by dissolving the potash into water, wherein contacting the potash solution with the resin removes the ammonium cation from the resin and replaces it with a potassium ion, and the resulting spent regeneration solution comprises a solution of ammonium chloride,

wherein optionally potassium chloride, or potash, is agricultural grade,

and optionally the ammonium chloride solution is further processed to recover the ammonia values (optionally, for recycle) by addition of lime and reaction of the lime with the ammonium chloride, resulting in the production of calcium chloride as a solution with the concurrent release of the ammonia as a vapor phase,

and optionally the lime is first received and processed in a slaking system to produce a slaked lime slurry that is then fed to a mixed tank reaction system, and the ammonium chloride converted to calcium chloride as follows:

2 NH₄Cl+Ca(OH)₂→2 NH₄OH+CaCl₂.

The invention provides methods for the production of an NPK-polyphosphate material using agricultural-grade phosphoric acid and potash in a continuous ion exchange resin comprising a process as set forth in FIG. 1. The invention provides methods for the production of an NPK-polyphos product comprising a process as set forth in FIG. 1. The invention provides methods for the production of an NH₄Cl solution product, or a dry NH₄Cl, comprising a process as set forth in FIG. 1. The invention provides methods for the production of an CaCl₂ solution product, or a dry CaCl₂, comprising a process as set forth in FIG. 1. The invention provides methods comprising any subset of processes as set forth in FIG. 1, or as set forth herein.

The details of one or more embodiments of the invention are set forth in the accompanying drawings and the description below. Other features, objects, and advantages of the invention will be apparent from the description and drawings, and from the claims.

All publications, patents and patent applications cited herein are hereby expressly incorporated by reference for all purposes.

### BRIEF DESCRIPTION OF THE DRAWINGS

The drawings set forth herein are illustrative of embodiments of the invention and are not meant to limit the scope of the invention as encompassed by the claims.

FIG. 1 schematically illustrates an exemplary process of the invention, in particular, an NPK-polyphosphate production process, and alternative exemplary processes of the invention comprising the production of a dry ammonium chloride product, and the conversion of the ammonium chloride to calcium chloride with subsequent recovery of the ammonia, as discussed in detail, below.

Like reference symbols in the various drawings indicate like elements, unless otherwise stated.

Reference will now be made in detail to various exemplary embodiments of the invention, examples of which are illustrated in the accompanying drawings. The following detailed description is provided to give the reader a better understanding of certain details of aspects and embodiments of the invention, and should not be interpreted as a limitation on the scope of the invention.

### DETAILED DESCRIPTION

In alternative embodiments, the invention provides processes comprising reacting agricultural-grade phosphoric acid with anhydrous ammonia to produce an ammonium polyphosphate solution (the so-called “K-Tech NPK-Poly process” of the invention). The reaction is carried out under high temperature conditions so that a portion of the phosphate contained in the starting acid solution is converted to a polyphosphate form; this step comprises use of standard reaction conditions, for example, as used to make products such as 10-34-0 and 11-37-0 (N-P-K), and N-P polyphosphates (ammonium polyphosphate solutions APP, 10-34-0, 11-37-0, are common liquid P fertilizer materials).\

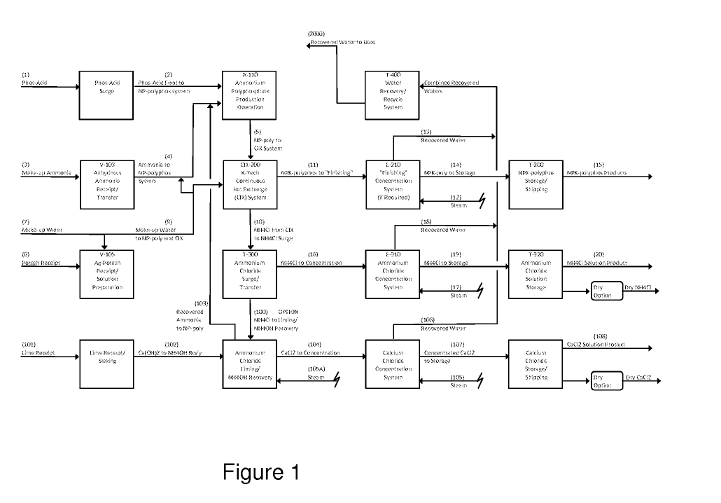

FIG. 1 schematically illustrates an exemplary process of the invention; in particular, it illustrates an exemplary overall process for an NPK-polyphosphate production process (the so-called “NPK-Polyphosphate Production Concept” of the invention). This figure also includes alternative exemplary processes of the invention comprising the production of a dry ammonium chloride product, as well as the conversion of the ammonium chloride to calcium chloride with subsequent recovery of the ammonia.

In alternative embodiments, the invention provides processes comprising the production of NPK-polyphosphates having a potassium source such as a potassium hydroxide, which can be used to allow for some level of acid neutralization and reaction with the phosphate anion (the KOH can be an expensive raw material). The general reaction for this step is as follows:

R—K++NH₄-poly phosphate R—NH₄++K-poly phosphate

where R is the IX resin phase.

In alternative embodiments, the N-P-polyphosphate solution is then processed in a continuous ion exchange system wherein a portion, substantially all, or all, of the ammonium ion is exchanged for a potassium cation that has been previously loaded on the ion exchange resin to produce an ammonium/potassium or full potassium polyphosphate solution. In alternative embodiments this solution is further evaporated, if need be, or used as-is since it will contain a very high level of total plant nutrient value.

After the exchange of the ammonium from the ammonium polyphosphate solution for the potassium contained on the resin, the resin is now in the ammonium phase and requires regeneration to convert it back to the potassium state. To accomplish this regeneration step, the resin is initially contacted with a small amount of water to wash the resin and remove any entrained phosphate solution. The resin is next contacted with a solution of potassium chloride (potash) that is prepared by dissolving ag-grade potash into water.

The strong potash solution is then contacted with the resin and then removes the ammonium cation from the resin and replaces it with a potassium ion. The resulting spent regeneration solution now comprises a solution of ammonium chloride, which can be used as an agricultural material or further processed to produce industrial grade ammonium chloride products.

This reaction (regeneration) can be illustrated as follows:

R—NH₄++KCl→R—K++NH₄Cl

In alternative embodiments, the ammonium chloride solution can also be further processed to recover the ammonia values (for recycle) via the addition of lime. Reaction of the lime with the ammonium chloride results in the production of calcium chloride, as a solution, with the concurrent release of the ammonia as a vapor phase.

This reaction would be as follows:

2 NH₄Cl+Ca(OH)₂→CaCl₂+2 NH₄OH

In alternative embodiments, the ammonium hydroxide is recovered for reuse. The calcium chloride can be concentrated to produce commercial grades of liquid CaCl₂ or dried to produce dry products.

In alternative embodiments, for the so-called K-Tech NPK-Poly Process, phosphoric acid (1) is received and surged. The phos-acid (2) is then fed to an ammonium polyphosphate production step where the acid is reacted with ammonia (4) to produce an ammonium polyphosphate solution (5). Anhydrous ammonia (3) is received and surged for use and make-up water (9A) is transferred into the system for concentration control (as required).

In alternative embodiments, the ammonium polyphosphate solution (5) is then transferred to the continuous ion exchange system where it is contacted with an ion exchange resin that is in the potassium (K+) form and a K/NH4 exchange carried out in a continuous fashion. This initial ion exchange reaction is as follows:

R—K+excess (NH₄)-POLY→R—NH₄+(NH₄)(K)-POLY

where R— is the resin phase and excess (NH₄)-POLY is used so that the resulting solution contains both the ammonium and potassium polyphosphate species.

It is important to note that the ratio of N and K in the product (11) can be varied and control is based on the amount of excess (NH₄)-POLY that is used in this ion exchange step; i.e. for higher potassium ratios, the amount of excess (NH₄)-POLY that would be used would be relatively small. For higher N/K ratios the excess (NH₄)-POLY would be increased.

In alternative embodiments, after the resin has been exhausted it is removed from the system (e.g., in a continuous fashion) and washed with a small amount of water to remove any entrained phosphate solution. This exemplary wash step is shown as the stream (9) make-up water stream.

In alternative embodiments, the agricultural-grade potash (6) is received and mixed with water (7) to produce a near saturated solution of potassium chloride which is then fed to the CIX system (8) to regenerate the ion exchange resin and prepare it for re-use in the polyphosphate production zone. The regeneration exchange reaction is as follows:

R—NH₄+KCl→R—K+NH₄Cl

where R— is the resin phase

In alternative embodiments, the co-product ammonium chloride solution (10) is produced and transferred to a surge tank system for subsequent processing or treatment to recover ammonia. A small amount of water (9) also can be used after this step for washing purposes.

In alternative embodiments, the NPK-POLY solution (11) is then transferred to a finishing step where water can be evaporated, if required, to produce very high nutrient concentrations. In this exemplary step, steam (12) is used in an evaporation system to remove any excess water (again if needed) and the water evaporated from the solution (13) is recovered for reuse. In alternative embodiments, the concentrated NPK-POLY solution (14) is transferred to a storage and loadout system for eventual distribution (15).

In alternative embodiments, the ammonium chloride solution produced as a co-product of this exemplary operation has its own agronomic uses and well as various industrial applications. Depending on the desired product mix, there are several possible ammonium chloride treatment options.

For example, in one case, the ammonium chloride solution (10) that is recovered from the CIX system, as regeneration solution, is surged and then further processed to produce an ammonium chloride product (if desired). The ammonium chloride solution (16) is fed to an evaporation system and the NH₄Cl concentrated to produce a specialty Amm/Chlor co-product (19). Steam (17) is used to carry out the evaporation and the water from the evaporation step (18) can be recovered for reuse.

Alternatively, in another exemplary embodiment, the NH₄Cl solution can be further crystallized, e.g., using well established and known methods, to produce an NH₄Cl crystal. The crystals can be dried then sold as dry product for various uses. In alternative embodiments, a second ammonium chloride treatment option comprises a liming step to convert the NH₄Cl to CaCl2 with subsequent NH₄OH recovery. In this exemplary step, some (or all) of the surged ammonium chloride (100) is sent to a liming step.

In alternative embodiments, the lime (101) is received and processed in a slaking system to produce a slaked lime slurry (102) that is then fed to a mixed tank reaction system and the ammonium chloride converted to calcium chloride as follows:

2 NH₄Cl+Ca(OH)₂→2 NH₄OH+CaCl₂

In alternative embodiments, the recovered ammonium hydroxide (103) is returned for use in the CIX process system.

In alternative embodiments, the calcium chloride solution (104) is then processed in an evaporation system with steam (105) used to provide the heating source. As in the other evaporation cases, the water (106) from this evaporation step can be recycled for reuse.

In alternative embodiments, the concentrated CaCl₂ (107) is then transferred to a storage/loadout system for subsequent distribution (108). Calcium chloride can also be dried to produce flaked and prilled products (a prill is a small aggregate of a material formed from a melted liquid, the prill can be a dry sphere or a product that has been pelletized)

A number of embodiments of the invention have been described. Nevertheless, it will be understood that various modifications may be made without departing from the spirit and scope of the invention. Accordingly, other embodiments are within the scope of the following claims.

1. A process for the production of NPK-polyphosphate materials using agricultural-grade phosphoric acid and potash in a continuous ion exchange resin.

2. The process of claim 1, wherein the continuous ion exchange resin is a weak cationic material.

3. The process of claim 1, wherein the continuous ion exchange resin is a strong cationic material.

4. A process of claim 1 comprising an initial treatment of the phosphoric acid with ammonia to produce an ammonium polyphosphate solution.

5. A process of claim 4 where the ammonium polyphosphate solution is then contacted in a continuous ion exchange system with an organic ion exchange resin that has been put into a potassium (K+) form to produce an ammonium/potassium polyphosphate steam that contains substantially no chloride values.

6. A process of claim 4 where the ion exchange resin, now loaded with ammonium, is contacted with a stream of potassium chloride solution to remove the ammonium ions from the resin as an ammonium chloride stream, and replace the ammonium ions with potassium ions for subsequent reuse of the resin in the regeneration stage.

7. A process of claim 4 where the amount of ammonium polyphosphate solution is such that a slight deficiency of ammonium ions are present for a full exchange with the production of a resulting polyphosphate solution that is substantially potassium polyphosphate.

8. The process of claim 4 where the ammonium chloride solution is evaporated and dried to produce a crystallized ammonium chloride product.

9. The process of claim 4 where the ammonium chloride solution is reacted with a mixture of slaked lime to produce a calcium chloride co-product with subsequent recovery of the ammonium hydroxide.

10. The process of claim 1, wherein the continuous ion exchange resin comprises a weak cationic material, and optionally the weak cationic material comprises: a weak acid resin; a weak acid, macroporous cation exchange resin; a DOWEX MWC-1™ (Dow Chemical Co., Midland, Mich.); a PUROLITE C-104+™ (Purolite, Bala Cynwyd, Pa.); or, an equivalent type of resin.

11. The process of claim 1, wherein the continuous ion exchange resin comprises: a strong cationic material; a strong cationic exchange resin; a DOW 650C™ (Dow Chemical Co., Midland, Mich.); a PUROLITE SST 60™ (Purolite, Bala Cynwyd, Pa.); a LANXESS 1368/320™ (Lanxess AG, Cologne, Germany); or, an equivalent type of resin.

12. The process of claim 4, wherein the ammonium polyphosphate solution is then contacted in a continuous ion exchange system comprising an organic ion exchange resin that has been put into a potassium (K+) form to produce an ammonium/potassium polyphosphate steam that comprises substantially no chloride values, at a temperature ranging from between about 60° F. to about 160° F., or between about 110° F. to about 130° F., and at a sufficient pressure to overcome the pressure drop associated with the resin beds.

13. The process of claim 4, wherein the ion exchange resin, now loaded with ammonium, is contacted with a stream of potassium chloride solution to remove the ammonium ions from the resin as an ammonium chloride stream, and replace the ammonium ions with potassium ions for subsequent reuse of the resin in the regeneration stage at a temperature ranging from between about 60° F. to about 160° F., or between about 110° F. to about 130° F., and at a pressure sufficient to overcome the pressure drop associated with the resin beds.

14. A process for the production of NPK-polyphosphate materials, or a liquid fertilizer solution that is substantially chloride-free, comprising:
(a) an initial treatment of a phosphoric acid with an ammonia to produce an ammonium polyphosphate solution, wherein optionally the phosphoric acid is agricultural grade;
(b) reaction of the ammonium polyphosphate solution to produce a potassium polyphosphate comprising the step:
R—K++NH₄-poly phosphate->R—NH₄++K-poly phosphate
where R is the IX resin phase,
wherein the potassium polyphosphate solution comprises an ammonium/potassium solution or a full potassium polyphosphate solution, and the resin is now in the ammonium phase,
and optionally the solution is further evaporated; and
(c) the resin, now in the ammonium phase, is regenerated to convert it back to the potassium state by a process comprising initially contacting the resin with a small amount of water to wash the resin and remove any entrained phosphate solution, and then the resin is contacted with a solution of potassium chloride (potash) prepared by dissolving the potash into water, wherein contacting the potash solution with the resin removes the ammonium cation from the resin and replaces it with a potassium ion, and the resulting spent regeneration solution comprises a solution of ammonium chloride,
wherein optionally potassium chloride, or potash, is agricultural grade,
and optionally the ammonium chloride solution is further processed to recover the ammonia values (optionally, for recycle) by addition of lime and reaction of the lime with the ammonium chloride, resulting in the production of calcium chloride as a solution with the concurrent release of the ammonia as a vapor phase,
and optionally the lime is first received and processed in a slaking system to produce a slaked lime slurry that is then fed to a mixed tank reaction system, and the ammonium chloride converted to calcium chloride as follows:
2 H₄Cl+Ca(OH)₂->>2 H₄OH+CaCl₂.

15. A method for the production of an NPK-polyphosphate material using agricultural-grade phosphoric acid and potash in a continuous ion exchange resin comprising a process as set forth in FIG. 1.

16. A method for the production of an NPK-polyphos product comprising a process as set forth in FIG. 1.

17. A method for the production of an NH4CI solution product, or a dry NH4Cl, comprising a process as set forth in FIG. 1.

18. A method for the production of an CaCl₂ solution product, or a dry CaCl₂, comprising a process as set forth in FIG. 1.

19. (canceled)
